(19) United States
(12) Patent Application Publication
(10) Pub. No.: US 2011/0103270 A1
(43) Pub. Date: May 5, 2011

(54) APPARATUS AND METHOD FOR CONFIGURING FRAME STRUCTURE IN FDD WIRELESS COMMUNICATION SYSTEM

(75) Inventors: Young-Bin CHANG, Anyang-si (KR); Rakesh TAORI, Suwon-si (KR); Mi-Hyun LEE, Seongnam-si (KR)

(73) Assignee: SAMSUNG ELECTRONICS CO. LTD., Suwon-si (KR)

(21) Appl. No.: 12/915,489

(22) Filed: Oct. 29, 2010

(30) Foreign Application Priority Data
Oct. 29, 2009 (KR) 10-2009-0103829

(51) Int. Cl. H04B 7/14

(52) U.S. Cl. 370/279

(57) ABSTRACT

An apparatus and method for reducing an overhead resulting from an transition gap in a Relay Station (RS) of a Frequency Division Duplex (FDD) wireless communication system are provided. The method includes determining transmission/reception transition time information through a negotiation with an upper node, identifying a signal delay time with the upper node, identifying a first reference time (R_Idle_Time), determining an overhead of a DownLink (DL) frame and an overhead of an UpLink (UL) frame resulting from transmission/reception transition in consideration of at least one of the transition time information, the signal delay time, the first reference time, and a second reference time (Idle_Time), and performing communication based on the overhead of the DL frame and the overhead of the UL frame.

### PRIORITY

This application claims priority under 35 U.S.C. §119(a) to a Korean patent application filed in the Korean Intellectual Property Office on Oct. 29, 2009 and assigned Serial No. 10-2009-0103829, the entire disclosure of which is hereby incorporated by reference.

### BACKGROUND OF THE INVENTION

1. Field of the Invention

The present invention relates to an apparatus and method for providing a relay service in a relay wireless communication system. More particularly, the present invention relates to an apparatus and method for configuring a frame structure, for providing a relay service in a Frequency Division Duplex (FDD) wireless communication system.

2. Description of the Related Art

To provide an excellent wireless channel to a Mobile Station (MS) located in a cell edge or shadow area, a wireless communication system provides a relay service using a Relay Station (RS). For example, the wireless communication system relays data transmitted/received between a Base Station (BS) and an MS using an RS as described below with reference to FIG. 1.

FIG. 1 illustrates a construction of a relay wireless communication system according to the related art.

As illustrated in FIG. 1, the wireless communication system includes a BS 100, an RS 110, an MS1 120, and an MS2 130.

The BS 100 performs direct communication with the MS1 120 located in its service coverage area.

The BS 100 performs communication with the MS2 130 located outside its service coverage area, using the RS 110. That is, the BS 100 provides an excellent wireless channel to an MS, which has a poor channel state because the MS is either located outside a service coverage area or is located in a shadow area where a heavy screening phenomenon occurs due to a building and the like, using the RS 110.

In a case where a relay service is provided as described above, the wireless communication system provides the relay service using a frame configured as illustrated in FIG. 2 below.

FIG. 2 illustrates a frame structure for a relay service in a Time Division Duplex (TDD) wireless communication system according to the related art.

As illustrated in FIG. 2, a frame of a relay wireless communication system is composed of a DownLink (DL) subframe 220 and an UpLink (UL) subframe 230. Here, the DL subframe 220 is divided into a DL access zone 222 and a DL relay zone 224, and the UL subframe 230 is divided into a UL access zone 232 and a UL relay zone 234. A Transmit/receive Transition Gap (TTG) 250 exists between the DL subframe 220 and the UL subframe 230. Similarly, a Receive/transmit Transition Gap (RTG) 270 exists after UL subframe 230.

A DL subframe 220 of a BS frame 200 is composed of a DL access zone 222 and a DL relay zone 224. During the DL access zone 222, a BS transmits a DL signal to an MS connected through a direct link. During the DL relay zone 224, the BS transmits a DL signal to an RS.

A UL subframe 230 of the BS frame 200 is composed of a UL access zone 232 and a UL relay zone 234. During the UL access zone 232, the BS receives a UL signal from the MS. During the UL relay zone 234, the BS receives a UL signal from the RS.

A DL subframe 220 of an RS frame 210 is composed of a DL access zone 222 and a DL relay zone 224. During the DL access zone 222, an RS transmits a DL signal to an MS connected through a relay link. During the DL relay zone 224, the RS receives a DL signal from the BS. A Relay-Transmit/receive Transition Gap (R-TTG) 240, an Orthogonal Frequency Division Multiplexing (OFDM) symbol overhead for transition of the RS between reception/transmission, exists between the DL access zone 222 and DL relay zone 224 of the DL subframe 220.

A UL subframe 230 of the RS frame 210 is composed of a UL access zone 232 and a UL relay zone 234. During the UL access zone 232, the RS receives a UL signal from the MS. During the UL relay zone 234, the RS transmits a UL signal to the BS. A Relay-Receive/transmit Transition Gap (R-RTG) 260, an OFDM symbol overhead for transition of the RS between reception/transmission, exists between the UL access zone 232 and UL relay zone 234 of the UL subframe 230.

The frame structure of the TDD wireless communication system is configured differently from a frame structure of a Frequency Division Duplex (FDD) wireless communication system. Accordingly, there is a need for a new definition of an R-RTG and an R-TTG for the frame structure of the FDD wireless communication system.

### SUMMARY OF THE INVENTION

An aspect of the present invention is to address at least the above-mentioned problems and/or disadvantages and to provide at least the advantages below. Accordingly, an aspect of the present invention is to provide an apparatus and method for supporting a relay service in a relay wireless communication system.

Another aspect of the present invention is to provide a method for configuring a frame structure, for supporting a relay service in a Frequency Division Duplex (FDD) wireless communication system, and an apparatus supporting the same.

A further aspect of the present invention is to provide an apparatus and method for setting a time guard zone for transition between reception/transmission of a Relay Station (RS) in an FDD wireless communication system.

The above aspects are addressed by providing an apparatus and method for configuring a frame structure in an FDD wireless communication system.

In accordance with an aspect of the present invention, an operation method of an RS in an FDD wireless communication system is provided. The method includes determining transmission/reception transition time information through a negotiation with an upper node, identifying a signal delay time with the upper node, identifying a first reference time (R_Idle_Time), determining an overhead of a DownLink (DL) frame and an overhead of an UpLink (UL) frame resulting from a transmission/reception transition in consideration of at least one of the transition time information, the signal delay time, the first reference time, and a second reference time (Idle_Time), and performing communication considering the overhead of the DL frame and the overhead of the UL frame. A start time point of the UL frame is set to precede a start time point of a UL frame of the upper node in consideration of the first reference time. The first reference time represents a time zone positioned between a UL frame of the RS and a next UL frame. The second reference time represents a time zone for constantly maintaining lengths of a DL frame of the upper node and a UL frame.

In accordance with another aspect of the present invention, an RS apparatus in an FDD wireless communication system is provided. The apparatus includes a timing controller, a first transmission/reception unit, and a second transmission/reception unit. The timing controller determines overheads of a DL frame and UL frame resulting from transmission/reception transition in consideration of at least one of a transmission/reception transition time determined through a negotiation with an upper node, a signal delay time with the upper node, a first reference time, and a second reference time (Idle_Time), and provides a timing signal for transmission/reception transition of the RS in consideration of the overheads of the DL frame and UL frame. The first transmission/reception unit transmits/receives a signal through a DL frequency band, and transitions between transmission/reception based on the timing signal provided from the timing controller. The second transmission/reception unit transmits/receives a signal through a UL frequency band, and transitions between transmission/reception based on the timing signal provided from the timing controller. The timing controller provides a timing signal for a start time point of the UL frame of the RS set to precede a start time point of a UL frame of the upper node in consideration of the first reference time. The first reference time represents a time zone positioned between a UL frame of the RS and a next UL frame. The second reference time represents a time zone for constantly maintaining lengths of a DL frame of the upper node and a UL frame.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a diagram illustrating a construction of a relay wireless communication system according to the related art;

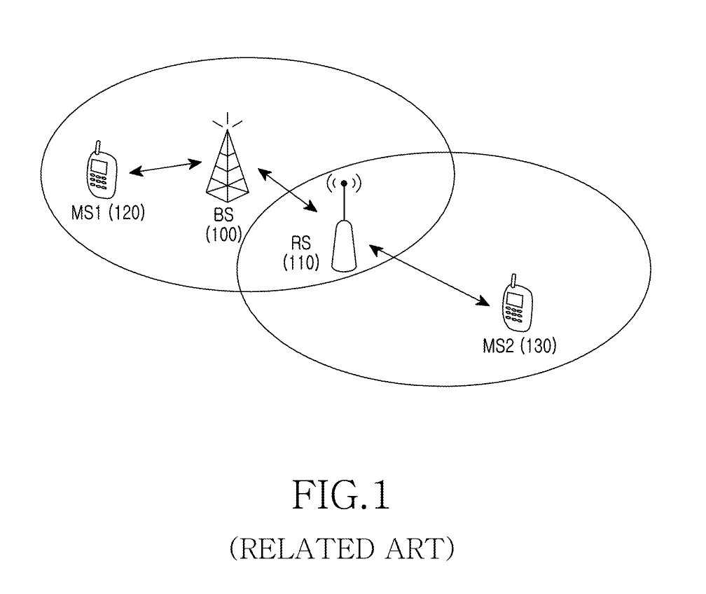

FIG. 2 is a diagram illustrating a frame structure for a relay service in a Time Division Duplex (TDD) wireless communication system according to the related art;

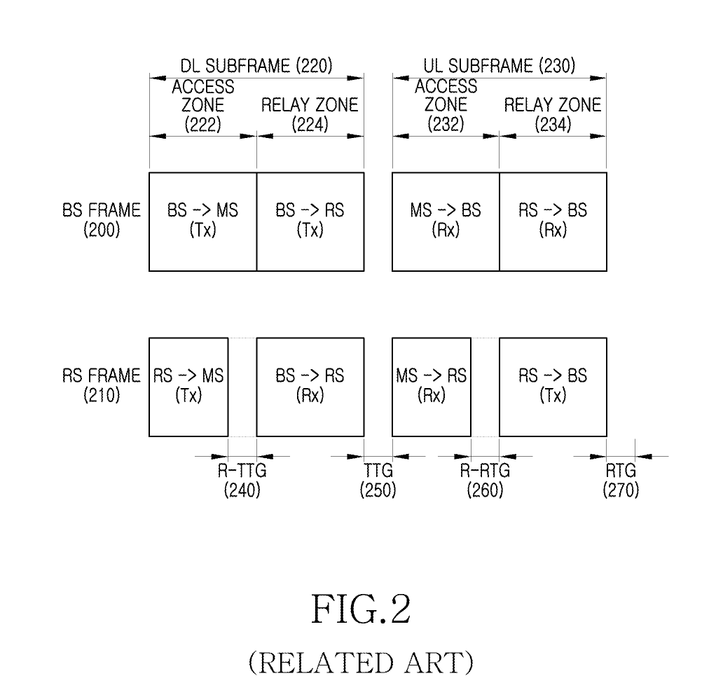

FIG. 3 is a diagram illustrating a DownLink (DL) frame structure for a relay service in a wireless communication system according to an exemplary embodiment of the present invention;

FIG. 4 is a diagram illustrating an UpLink (UL) frame structure for a relay service in a wireless communication system according to an exemplary embodiment of the present invention;

FIG. 5 is a flow diagram illustrating an operation procedure of a Base Station (BS) in a relay wireless communication system according to an exemplary embodiment of the present invention;

FIG. 6 is a flow diagram illustrating an operation procedure of a Relay Station (RS) in a relay wireless communication system according to an exemplary embodiment of the present invention;

FIG. 7 is a block diagram illustrating an RS apparatus in a relay wireless communication system according to an exemplary embodiment of the present invention; and

FIG. 8 is a block diagram illustrating an RS apparatus in a relay wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A technology for reducing an overhead resulting from a transition gap in a relay wireless communication system according to exemplary embodiments of the present invention are described below.

The following description is made on the assumption that a wireless communication system uses a Frequency Division Duplexing (FDD) scheme. However, the present invention is similarly applicable to other schemes.

In the following description, a two-hop wireless communication system is assumed. Accordingly, an upper node of a Relay Station (RS) represents a Base Station (BS), and a lower node of the RS represents a Mobile Station (MS). However, the present invention is identically applicable to a three-hop or multi-hop wireless communication system. In this case, an upper node of an RS represents a BS or an upper RS, and a lower node of the RS represents an MS or a lower RS.

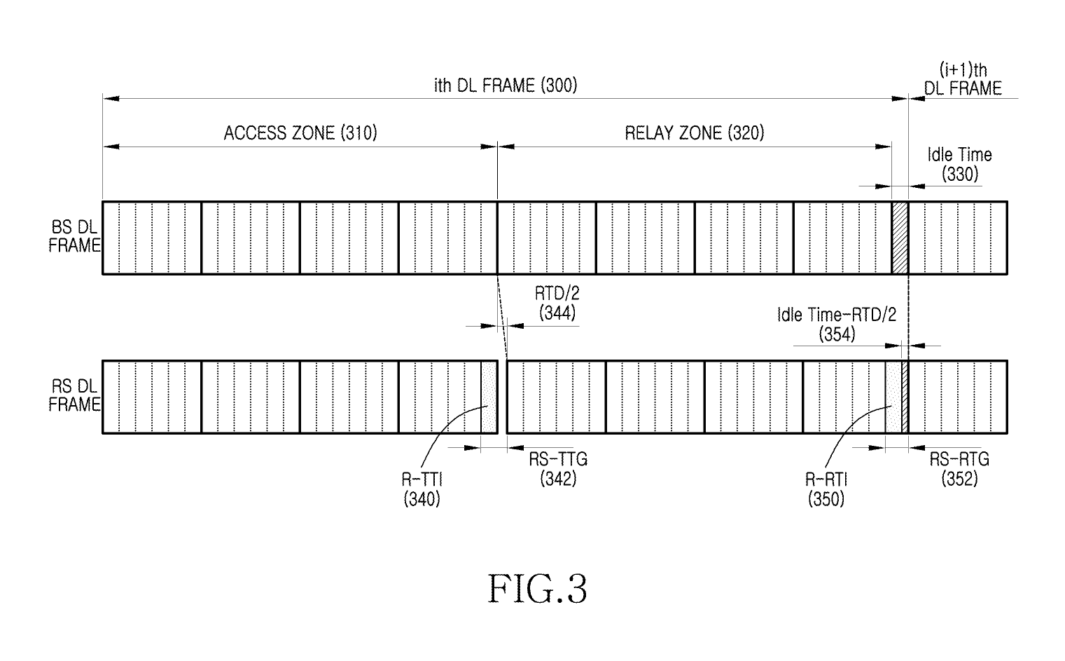

In an FDD wireless communication system, a transmit/receive end performs communication using different frequency bands of an UpLink (UL) and a DownLink (DL). Accordingly, the FDD wireless communication system differently configures a DL frame and a UL frame. First, the DL frame of the FDD wireless communication system is configured as described below with reference to FIG. 3.

FIG. 3 illustrates a DL frame structure for a relay service in a wireless communication system according to an exemplary embodiment of the present invention.

Referring to FIG. 3, a DL frame 300 of an FDD wireless communication system is composed of a DL access zone 310 and a DL relay zone 320.

A BS DL frame is composed of a DL access zone 310 and a DL relay zone 320. During the DL access zone 310, a BS transmits a DL signal to an MS connected through a direct link. During the DL relay zone 320, the BS transmits a DL signal to an RS. During the DL relay zone 320, the BS can also transmit a DL signal to the MS connected through the direct link.

In the case of the BS DL frame, an Idle_Time 330 exists between a frame and another frame. The Idle_Time 330 represents a zone for maintaining a constant length of a DL frame. That is, the Idle_Time 330 is used for constantly maintaining the total length of a frame despite there being a change of a length of one Orthogonal Frequency Division Multiplexing (OFDM) symbol due to a system Bandwidth (BW) or a length of a Cyclic Prefix (CP).

An RS DL frame is composed of a DL access zone 310 and a DL relay zone 320. During the DL access zone 310, an RS transmits a DL signal to an MS connected through a relay link. During the DL relay zone 320, the RS receives a DL signal from the BS.

A RS-Transmit/receive Transition Gap (RS-TTG) 342, a time zone for transition of the RS between reception/transmission, exists between the DL access zone 310 and DL relay zone 320 of the RS DL frame. The RS DL frame includes a Relay-Transmit/receive Transition Interval (R-TTI) 340 that is an OFDM symbol overhead resulting from the RS-TTG 342. For example, the R-TTI 340 can be expressed as in Equation 1 below. In a case where a value of the R-TTI 340 includes at least one OFDM symbol, the OFDM symbol for the R-TTI 340 can be included in the DL access zone 310 or DL relay zone 320.

$$R \text{-} TTI = \{ \begin{matrix}0 & if RTD / 2 \geq RSTTG \\ OFDMSymbolUnit ( RSTTG - RTD / 2 ) & if RTD / 2 < RSTTG\end{matrix} \\ OFDMSymbolUnit ( x ) = ⌈ x / OFDMSymboltime ⌉ \qquad ( 1 )$$

In Equation 1, ‘R-TTI’ 340 represents an overhead of an OFDM symbol unit resulting from transition of the RS between reception/transmission in the DL frame of the RS, the ‘Round-Trip Delay (RTD)/2’ represents a signal delay time between the BS and the RS, and the ‘RSTTG’ represents a time zone used for the transition from a transmit mode to a receive mode in a physical device of the RS. At this time, the ‘RSTTG’ corresponds to a physical capability of the RS.

In Equation 1, the ‘RSTTG’ generally has a value greater than the ‘RTD/2’ 344, and has a value less than one OFDM symbol value. Accordingly, the R-TTI 340 has a value of ‘1’. That is, the R-TTI 340 has a size of one OFDM symbol.

The RS-TTG 342 and the ‘RSTTG’ are values different from each other. The RS-TTG 342 represents a time zone existing between the DL access zone 310 and DL relay zone 320 of the RS DL frame. The ‘RSTTG’ represents a time zone for the transition from the transmit mode to the receive mode in the physical device of the RS. That is, the RS-TTG 342 is a time during which the RS transitions from the transmit mode to the receive mode, and the ‘RSTTG’ denotes an amount of time consumed for the transition between reception/transmission. Accordingly, the RS-TTG 342 has a value greater than or equal to the ‘RSTTG’ value.

An RS-Receive/transmit Transition Gap (RS-RTG) 352, a time zone for transition of the RS between reception/transmission, exists between the DL relay zone 320 of the RS DL frame and a DL access zone of a next DL frame. The RS DL frame includes a Relay-Receive/transmit Transition Interval (R-RTI) 350 that is an OFDM symbol overhead resulting from the RS-RTG 352. Here, in a case where a value of the R-RTI 350 includes at least one OFDM symbol, the OFDM symbol for the R-RTI 350 can be included in the DL relay zone 320 constituting the RS DL frame.

In a case where the RS receives a DL signal from the BS, a delay is generated by as much as an ‘RTD/2’ 344. Accordingly, a time zone as much as ‘Idle_Time-RTD/2’ 354 exists between the DL relay zone 320 of the RS DL frame and a DL access zone of a next DL frame. In this case, the ‘R-RTI’ 350 can be expressed as in Equation 2 below.

$$R \text{-} RTI = \{ \begin{matrix}0 & if Idle\_Time - RTD / 2 \geq RSRTG \\ \begin{matrix}OFDMSymbolUnit \\ ( RSRTG - Idle\_Time + RTD / 2 )\end{matrix} & if Idle\_Time - RTD / 2 < RSRTG\end{matrix} \\ OFDMSymbolUnit ( x ) = ⌈ x / OFDMSymboltime ⌉ \qquad ( 2 )$$

In Equation 2, the ‘R-RTI’ 350 represents an overhead of an OFDM symbol unit for the DL relay zone 320 of the RS DL frame, the ‘RTD/2’ represents a signal delay time between the BS and the RS, the ‘Idle_Time’ represents a time zone existing between a frame and another frame to maintain a constant length of the frame, and the ‘RSRTG’ represents a time zone used for the transition from the receive mode to the transmit mode in the physical device of the RS. At this time, the ‘RSRTG’ corresponds to a physical capability of the RS.

In Equation 2, in a case where the ‘RSRTG’ value is greater than the ‘Idle_Time-RTD/2’ 354 (Idle_Time-RTD/2<RSRTG), the R-RTI 350 has a value of ‘1’. That is, the R-RTI 350 has a size of one OFDM symbol. On the other hand, in a case where the ‘RSRTG’ value is less than the ‘Idle_Time-RTD/2’ 354 (Idle_Time-RTD/2>RSRTG), the R-RTI 350 has a value of ‘0’. That is, the R-RTI 350 does not need an OFDM symbol acting as an overhead in the DL relay zone 320 of the RS DL frame.

The RS-RTG 352 and the ‘RSRTG’ are values different from each other. The RS-RTG 352 represents a time zone existing between the DL relay zone 320 of the RS DL frame and a DL access zone of a next DL frame. The ‘RSRTG’ represents a time zone for the transition from the receive mode to the transmit mode in the physical device of the RS. That is, the RS-RTG 352 is a time during which the RS transitions from the receive mode to the transmit mode, and the ‘RSRTG’ is an amount of time consumed for the transition between reception/transmission. Accordingly, the RS-RTG 352 has a value greater than the ‘RSRTG’ value.

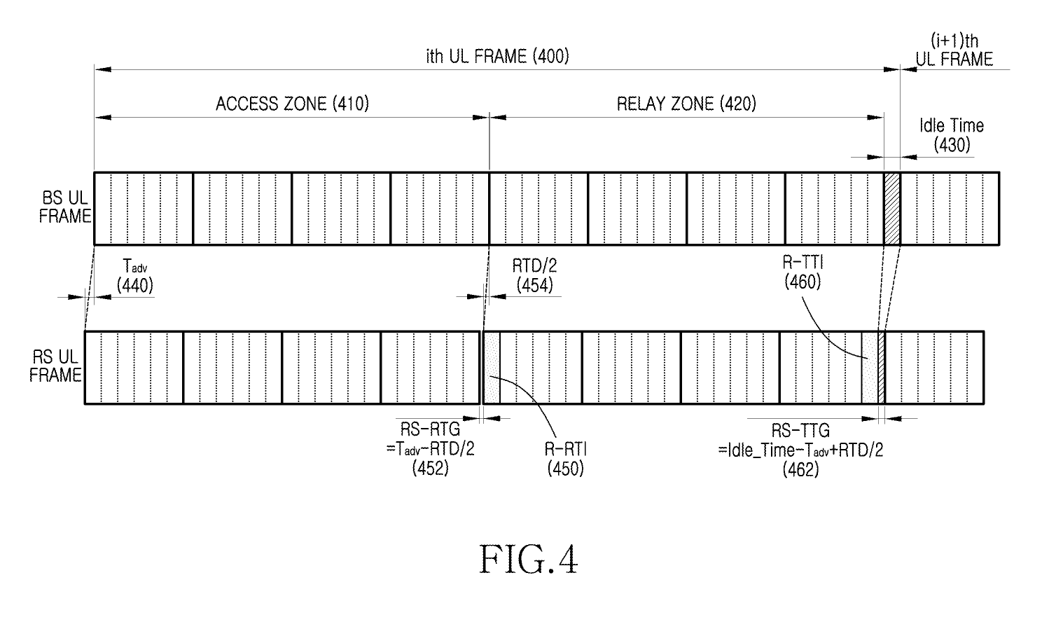

A UL frame of an FDD wireless communication system is configured as described below with reference to FIG. 4.

FIG. 4 illustrates a UL frame structure for a relay service in a wireless communication system according to an exemplary embodiment of the present invention.

Referring to FIG. 4, a UL frame 400 of an FDD wireless communication system is composed of a UL access zone 410 and a UL relay zone 420.

A BS UL frame is composed of a UL access zone 410 and a UL relay zone 420. During the UL access zone 410, a BS receives a UL signal from an MS connected through a direct link. During the UL relay zone 420, the BS receives a UL signal to an RS. During the UL relay zone 420, the BS can also receive a UL signal to the MS connected through the direct link.

In the case of the BS UL frame, an Idle_Time 430 exists between a frame and another frame. The Idle_Time 430 represents a zone for maintaining a constant length of a UL frame. That is, the Idle_Time 430 is used for constantly maintaining the total length of a frame despite there being a change of a length of one OFDM symbol depending on a system BW or a length of a CP.

An RS UL frame is composed of a UL access zone 410 and a UL relay zone 420. During the UL access zone 410, an RS receives a UL signal from an MS connected through a relay link. During the UL relay zone 420, the RS transmits a UL signal to the BS.

A RS-Receive/transmit Transition Gap (RS-RTG) 452, a time zone for transition of the RS between reception/transmission, exists between the UL access zone 410 and UL relay zone 420 of the RS UL frame. The RS UL frame includes a Relay-Receive/transmit Transition Interval (R-RTI) 450 that is an OFDM symbol overhead resulting from the RS-RTG 452. In a case where a value of the R-RTI 450 includes at least one OFDM symbol, the OFDM symbol for the R-RTI 450 can be included in the UL access zone 410 or UL relay zone 420 constituting the RS UL frame.

An RS-Transmit/receive Transition Gap (RS-TTG) 462, a time zone for transition of the RS between reception/transmission, exists between the UL relay zone 420 of the RS UL frame and a UL access zone of a next UL frame. The RS UL frame includes a Relay-Transmit/receive Transition Interval (R-TTI) 460 that is an OFDM symbol overhead resulting from the RS-TTG 462. Here, in a case where a value of the R-TTI 460 includes at least one OFDM symbol, the OFDM symbol for the R-TTI 460 is included in the UL relay zone 420 constituting the RS UL frame.

In a case where a value of adding an RSTTG of the RS to an RSRTG is less than the Idle_Time 430 of the BS UL frame, the UL access zone 410 of the RS UL frame is positioned as much as ‘Tadv’ 440 in advance of the UL access zone 410 of the BS UL frame.

In this case, a time zone ‘Tadv-RTD/2’ existing between the UL access zone 410 and UL relay zone 420 of the RS UL frame can be set as the RS-RTG 452.

The RS transmits a signal at a time point preceding by as much as ‘RTD/2’ 454 such that the BS can receive the signal transmitted by the RS at a start time point of the UL relay zone 420 of the BS UL frame. At this time, a time zone ‘Idle_Time+RTD/2-Tadv’ existing between the UL relay zone 420 of the RS UL frame and a UL access zone of a next UL frame can be set as the RS-TTG 462. Accordingly, the R-RTI 450 and R-TTI 460 of the RS UL frame can be expressed as in Equation 3 below.

R−RTI=R−TTI=0 if Idle_Time≧RSTTG+RSRTG (3)

In Equation 3, the ‘R-RTI’ 450 represents an overhead of an OFDM symbol unit in the RS UL frame, the ‘R-TTI’ 460 represents an overhead of an OFDM symbol unit for the UL relay zone 420 of the RS UL frame, the ‘Idle_Time’ 430 represents a time zone existing between a frame and another frame to maintain a constant length of the frame, the ‘RSRTG’ represents a time zone used for the transition from a receive mode to a transmit mode in a physical device of the RS, and the ‘RSTTG’ represents a time zone used for the transition from the transmit mode to the receive mode in the physical device of the RS. At this time, the RSRTG and RSTTG correspond to a physical capability of the RS.

In a case where the total sum (RSTTG+RSRTG) of an amount of time for a transition of the RS between reception/transmission is less than the Idle_Time 430 in Equation 3, the RS can transition between reception/transmission using the Idle_Time 430. For example, the RS can determine the T_{adv} 440 such that the RS can transition between reception/transmission using the Idle_Time 430. In a case where the UL access zone 410 of the RS UL frame is positioned as much as the T_{adv} 440 in advance of the UL access zone 410 of the BS UL frame, the time zone ‘T_{adv}-RTD/2’ 452 during which the RS can transition between reception/transmission exists between the UL access zone 410 and UL relay zone 420 of the RS UL frame. Also, the time zone ‘Idle_Time+RTD/2-T_{adv}’ 462 during which the RS can transition exists between the UL relay zone 420 of the RS UL frame and a UL access zone of a next UL frame. Accordingly, as in Equation 3, the RS UL frame does not generate an overhead resulting from the transition of the RS between reception/transmission.

As described above, the RS configures the UL access zone 410 of the RS UL frame such that the RS is positioned in advance as much as the T_{adv}. In this case, an R_Idle_Time exists between RS UL frames. For example, the R-Idle_Time can be expressed as in Equation 4 below. Here, the R_Idle_Time represents a time zone used for configuring an RS UL frame of a constant length, not a time zone for transition between transmission/reception of the RS.

R_Idle_Time=Idle_Time−T_{adv} (4)

In Equation 4, the ‘R_Idle_Time’ represents a time zone existing between RS UL frames, the ‘Idle_Time’ 430 represents a time zone existing between BS UL frames, and the ‘T_{adv}’ 440 represents a time zone advancing the UL access zone 410 of the RS UL frame.

If the T_{ad}, 440 is equal to ‘0’ in Equation 4, the R_Idle_Time has the same value as the Idle_Time 430 of the BS UL frame.

If the ‘RSTTG’ and ‘RSRTG’ value of the RS is greater than the Idle_Time 430 value of the BS UL frame, the RS cannot transition between reception/transmission using the Idle_Time 430. Accordingly, any one of the R-RTI 450 and the R-TTI 460 is configured to have ‘1’. That is, any one of the R-RTI 450 and the R-TTI 460 is configured as one OFDM symbol. For example, the R-RTI 450 and R-TTI 460 can be expressed as in Equation 5 below.

$$\begin{matrix}R \text{-} TTI = 0 , R \text{-} RTI = 1 \\ R \text{-} TTI = 1 , R \text{-} RTI = 0\end{matrix} \} if Idle\_Time < RSTTG + RSRTG \qquad ( 5 )$$

In Equation 5, the ‘R-RTI’ 450 represents an overhead of an OFDM symbol unit resulting from a transition between reception/transmission of an RS in an RS UL frame, the ‘R-TTI’ 460 represents an overhead of an OFDM symbol unit resulting from a transition between transmission/reception of the RS in the RS UL frame, the ‘Idle_Time’ 430 represents a time zone existing between BS UL frames, the ‘RSRTG’ represents a time zone used for the transition from a receive mode to a transmit mode in a physical device of the RS, and the ‘RSTTG’ represents a time zone used for the transition from the transmit mode to the receive mode in the physical device of the RS. At this time, the RSRTG and RSTTG correspond to a physical capability of the RS.

In a case where a value of ‘Idle_Time+RTD/2’ is greater than the ‘RSTTG’ in Equation 5, the R-TTI 460 inevitably should have at least one OFDM symbol. That is, in a case where the value of ‘Idle_Time+RTD/2’ is greater than the ‘RSTTG’, the R-TTI 460 can be expressed as in Equation 6 below.

$$R \text{-} TTI = 1 , R \text{-} RTI = 0 if \{ \begin{matrix}Idle\_Time < RSTTG + RSRTG and \\ Idle\_Time + RTD / 2 < RSTTG\end{matrix} \qquad ( 6 )$$

In Equation 6, the ‘R-RTI’ 450 represents an overhead of an OFDM symbol unit resulting from a transition between reception/transmission of an RS in an RS UL frame, the ‘R-TTI’460 represents an overhead of an OFDM symbol unit resulting from a transition between transmission/reception in the RS UL frame, the ‘Idle_Time’ 430 represents a time zone existing between BS UL frames, the ‘RSRTG’ represents a time zone used for the transition from a receive mode to a transmit mode in a physical device of the RS, and the ‘RSTTG’ represents a time zone used for the transition from the transmit mode to the receive mode in the physical device of the RS. At this time, the RSRTG and RSTTG correspond to a physical capability of the RS.

In Equations 5 and 6, it is assumed that one OFDM symbol is greater than or equal to the total sum (RSTTG+RSRTG) of the amount of time for transition of the RS between reception/transmission. Accordingly, any one of the R-RTI 450 and the R-TTI 460 has a value of ‘1’. If one OFDM symbol is less than the total sum (RSTTG+RSRTG) of an amount of time for transition of the RS between reception/transmission, any one of the R-RTI 450 and R-TTI 460 has a value of ‘1’ or more. Or, the R-RTI 450 and the R-TTI 460 each may have a value of ‘1’ or more. Here, the ‘1’ represents one OFDM symbol.

The following description is made for an operation method of a BS for transmitting transition zone information of an RS in a wireless communication system.

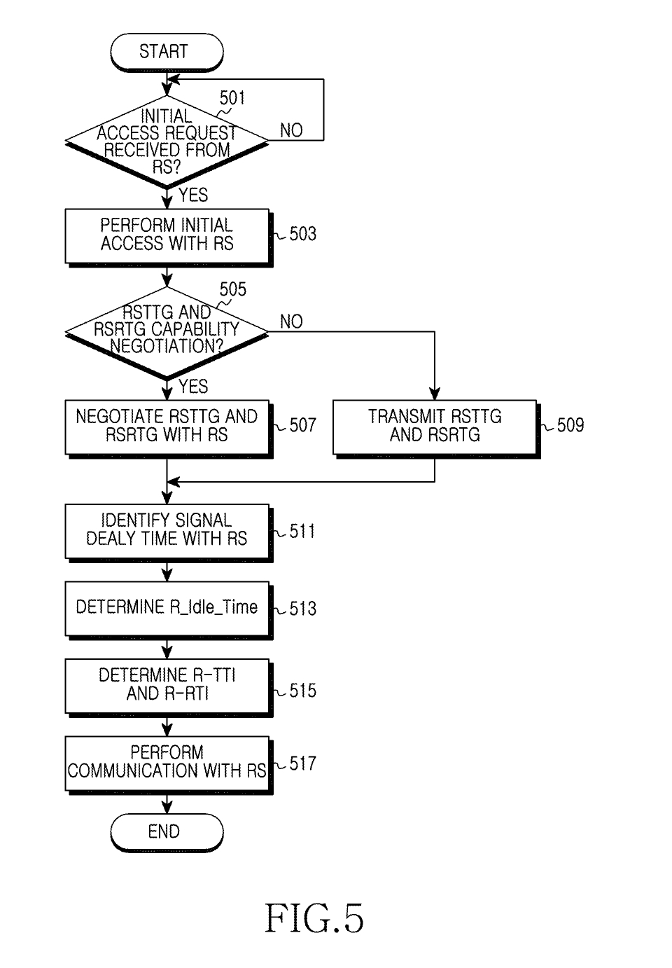

FIG. 5 illustrates an operation procedure of a BS in a relay wireless communication system according to an exemplary embodiment of the present invention.

Referring to FIG. 5, in step 501, the BS identifies if an initial access request message is received from an RS.

If the initial access request message is received from the RS, the BS proceeds to step 503 and performs an initial access procedure for the RS.

After that, the BS proceeds to step 505 and determines whether to negotiate an RSTTG and an RSRTG with the RS. For example, the BS determines whether to negotiate an RSTTG and an RSRTG through a capability negotiation with the RS. At this time, the BS can either perform the capability negotiation with the RS during initial access performance or perform the capability negotiation with the RS after the initial access performance.

If it is determined to negotiate the RSTTG and RSRTG with the RS, the BS proceeds to step 507 and negotiates the RSTTG and RSRTG with the RS. At this time, the BS negotiates the RSTTG and RSRTG through the capability negotiation with the RS. For example, in order to negotiate an RSTTG and an RSRTG with the RS, the BS identifies the maximum values of the RSTTG and RSRTG. Then, the BS identifies an RSTTG and an RSRTG transmitted by the RS. That is, the BS identifies an RSTTG and an RSRTG desired by the RS. The BS transmits either an RSTTG and an RSRTG determined considering the RSTTG and RSRTG desired by the RS or a response signal to the RSTTG and RSRTG desired by the RS, to the RS. Here, the maximum values of the RSTTG and RSRTG may be set as system information and may be previously known to the BS and RS or may be determined in the BS and informed to the RS through broadcasting information. Also, the BS can set a different RSTTG and RSRTG by RS.

After negotiating the RSTTG and RSRTG with the RS in step 507, the BS proceeds to step 511 and identifies a signal delay time with the RS. For example, the BS identifies a signal delay time acquired from the initial access process or random access process with the RS.

On the other hand, if it is determined not to negotiate the RSTTG and RSRTG with the RS in step 505, the BS proceeds to step 509 and determines and transmits an RSTTG and an RSRTG of the RS to the RS. For example, during initial access with the RS, the BS transmits the RSTTG and RSRTG to the RS. In another example, after the initial access with the RS, the BS may transmit the RSTTG and RSRTG to the RS. In yet another example, before the initial access performance with the RS, the BS may transmit the RSTTG and RSRTG to the RS. At this time, the BS transmits the RSTTG and RSRTG to the RS using broadcasting information.

After transmitting the RSTTG and RSRTG to the RS in step 509, the BS proceeds to step 511 and identifies a signal delay time with the RS. For example, the BS identifies a signal delay time acquired from the initial access process or random access process with the RS.

After identifying the signal delay time with the RS, the BS proceeds to step 513 and determines a time zone ‘R_Idle_Time’ to be set between RS UL frames. For example, the BS determines the ‘R_Idle_Time’ value considering its own cell coverage information and cell coverage information of the RS. Here, the cell coverage information of the RS is provided from the RS. Although not illustrated, the BS may transmit the determined ‘R_Idle_Time’ to the RS through the broadcasting information or in the initial access process.

After determining the ‘R_Idle_Time’ value, the BS proceeds to step 515 and determines a DL overhead (R-TTI) of the RS and a UL overhead (R-RTI) using the RSTTG and RSRTG information of the RS, an ‘Idle_Time’, the ‘R_Idle_Time’, and the signal delay time with the RS. That is, the BS determines a DL overhead and a UL overhead resulting from the transition of the RS between reception/transmission for the sake of being in synchronization with the RS. For example, the BS determines an R-TTI 340 and an R-RTI 350 of an RS DL frame using Equations 1 and 2. For another example, the BS determines an R-TTI 460 and an R-RTI 450 of an RS UL frame using Equation 3 or 5.

After determining the UL overhead and DL overhead resulting from the transition of the RS between reception/transmission, the BS proceeds to step 517 and performs communication with the RS considering the DL overhead and UL overhead resulting from the transition of the RS between reception/transmission.

After that, the BS terminates the procedure according to the exemplary embodiment of the present invention.

In the aforementioned exemplary embodiment, upon initial access with an RS, a BS either negotiates an RSTTG and an RSRTG with the RS or transmits the RSTTG and RSRTG to the RS.

In another exemplary embodiment, in addition, while in an initial access with an RS, in an access state with the RS, a BS may either negotiate an RSTTG and an RSRTG with the RS or transmit the RSTTG and RSRTG to the RS. That is, in a case where there is a change of a signal delay time between the BS and the RS, the BS may either again negotiate RSTTG and RSRTG information with the RS or again generate and transmit an RSTTG and an RSRTG to the RS.

In the aforementioned exemplary embodiment, a BS determines an ‘R_Idle_Time’ of an RS frame.

In another exemplary embodiment, a BS and an RS may use a fixed ‘R_Idle_Time’. If the RS is not aware of the fixed ‘R_Idle_Time’, the BS may transmit the ‘R_Idle_Time’ information to the RS through broadcasting information or in an initial access process.

In the aforementioned exemplary embodiment, after identifying a signal delay time with an RS, a BS determines an ‘R_Idle_Time’ value that is a time zone between RS UL frames (in step 513). That is, in a case where the ‘R_Idle_Time’ is different from an ‘Idle_Time’ by as much as T_{adv} 440 in FIG. 4, the BS determines the ‘R_Idle_Time’ that is a different value from the ‘Idle_Time’.

In another exemplary embodiment, in a case where T_{adv} 440 is equal to ‘0’, an ‘R_Idle_Time’ and an ‘Idle_Time’ have the same value. Accordingly, in a case where the T_{adv} 440 is equal to ‘0’, the BS can omit a process (step 513) of determining the ‘R_Idle_Time’.

In the aforementioned exemplary embodiment, a BS determines and transmits an ‘R_Idle_Time’ to an RS.

In another exemplary embodiment, a BS may determine and transmit T_{adv} to an RS.

In a case where the BS determines the ‘R_Idle_Time’ as above, the BS may determine the same ‘R_Idle_Time’ applicable to all RSs or determine a different ‘R_Idle_Time’ every RS.

The following description is made for an operation procedure of an RS for setting an R-TTI and an R-RTI.

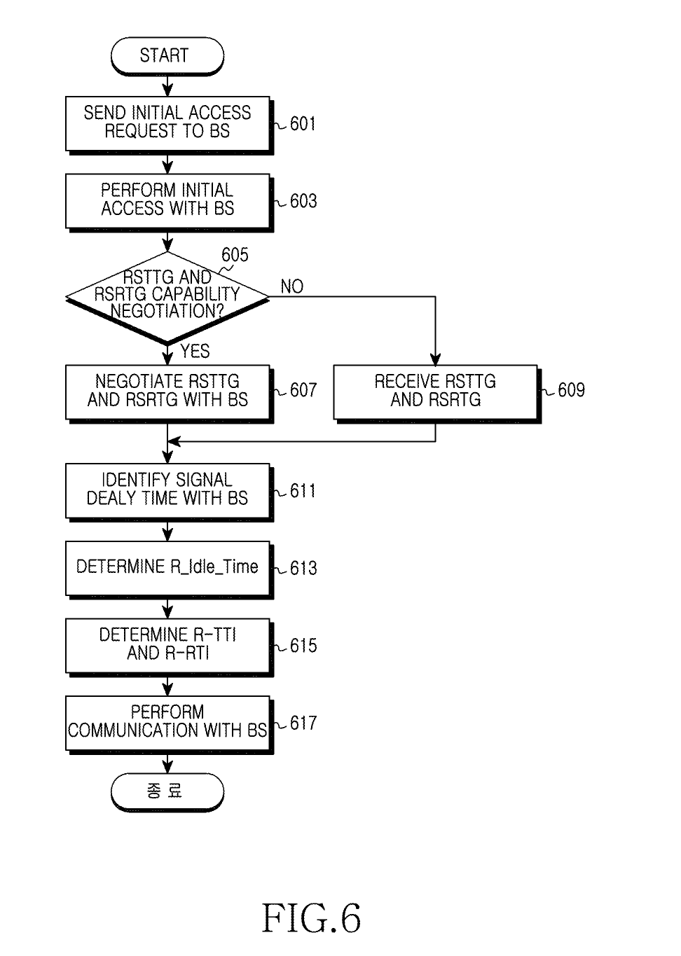

FIG. 6 illustrates an operation procedure of an RS in a relay wireless communication system according to an exemplary embodiment of the present invention.

Referring to FIG. 6, in step 601, the RS sends an initial access request to a BS.

After sending the initial access request to the BS, the RS proceeds to step 603 and performs an initial access procedure with the BS.

After that, the RS proceeds to step 605 and determines whether to negotiate an RSTTG and an RSRTG with the BS. For example, the RS determines whether to negotiate an RSTTG and an RSRTG through a capability negotiation with the BS. At this time, the RS can either perform the capability negotiation with the BS during initial access performance with the BS or perform the capability negotiation with the BS after the initial access performance.

If it is determined to negotiate the RSTTG and RSRTG with the BS in step 605, the RS proceeds to step 607 and negotiates the RSTTG and RSRTG with the BS. At this time, the RS negotiates the RSTTG and RSRTG through the capability negotiation with the BS. For example, in order to negotiate an RSTTG and an RSRTG with the BS, the RS determines and transmits an RSTTG and an RSRTG desired by the RS itself to the BS. At this time, the RS determines the RSTTG and RSRTG desired by the RS itself in consideration of the maximum values of an RSTTG and an RSRTG. After that, the RS receives either a response signal to the RSTTG and RSRTG transmitted to the BS or an RSTTG and RSRTG determined in the BS, from the BS. Here, the maximum values of the RSTTG and RSRTG can be either set as system information or can be provided from the BS through broadcasting information.

After negotiating the RSTTG and RSRTG with the BS in step 607, the RS proceeds to step 611 and identifies a signal delay time with the BS. For example, the RS identifies a signal delay time acquired from the initial access process or random access process with the BS.

On the other hand, if it is determined not to negotiate the RSTTG and RSRTG with the BS in step 605, the RS proceeds to step 609 and receives RSTTG and RSRTG information from the BS. For example, during initial access performance, the RS receives the RSTTG and RSRTG information broadcasted in the BS. In another example, after the initial access performance, the RS may receive the RSTTG and RSRTG information broadcasted in the BS. In yet another example, before the initial access performance, the RS may receive the RSTTG and RSRTG broadcasted in the BS.

After receiving the RSTTG and RSRTG information from the BS in step 609, the RS proceeds to step 611 and identifies a signal delay time with the BS. For example, the RS identifies a signal delay time acquired from the initial access process or random access process with the BS.

After identifying the signal delay time with the BS in step 611, the RS proceeds to step 613 and identifies an ‘R_Idle_Time’ that is a time zone between RS UL frames. For example, the RS identifies the ‘R_Idle_Time’ in a broadcasting signal received from the BS. In another example, the RS may receive the ‘R_Idle_Time’ information from the BS in the initial access process with the BS. In another example, the RS may identify the ‘R_Idle_Time’ fixed in a system. Although not illustrated, the RS can transmit the ‘R_Idle_Time’ information to an MS connected through a relay link.

After identifying the ‘R_Idle_Time’, the RS proceeds to step 615 and determines a DL overhead (R-TTI) and a UL overhead (R-RTI) resulting from a transition between reception/transmission using the RSTTG and RSRTG information, an ‘Idle_Time’, the ‘R_Idle_Time’, and the signal delay time with the BS. For example, the RS determines an R-TTI 340 and an R-RTI 350 of an RS DL frame using Equations 1 and 2. In another example, the RS can determine an R-TTI 460 and an R-RTI 450 of an RS UL frame using Equation 3 or 5. In yet another example, the RS can receive values of an R-TTI 340 or 460 and an R-RTI 350 or 450 determined in the BS, as broadcasting information from the BS. Here, the RS may identify the ‘Idle_Time’ together when identifying the ‘R_Idle_Time’.

After determining the DL overhead (R-TTI) and the UL overhead (R-RTI), the RS proceeds to step 617 and performs communication with the BS in consideration of the DL overhead (R-TTI) and the UL overhead (R-RTI).

After that, the RS terminates the procedure according to the exemplary embodiment of the present invention.

In the aforementioned exemplary embodiment, an RS determines R-TTI and R-RTI information that are overheads resulting from a transition between reception/transmission, using RSTTG and RSRTG information negotiated with a BS or provided from the BS.

In another exemplary embodiment, an RS may identify an R-TTI and an R-RTI determined and transmitted in a BS.

In the aforementioned exemplary embodiment, after identifying a signal delay time with a BS, an RS identifies an ‘R_Idle_Time’. However, in a case where a start point of an RS UL frame is the same as a start point of a BS UL frame, the ‘R_Idle_Time’ has the same value as an ‘Idle_Time’. In this case, the RS can omit a process (step 613) of identifying the ‘R_Idle_Time’.

In the aforementioned exemplary embodiment, an RS receives an ‘R_Idle_Time’ from a BS. In another exemplary embodiment, the RS may determine the ‘R_Idle_Time’ using T_{ads} received from the BS.

The following description is made for a construction of an RS for setting an R-TTI and an R-RTI.

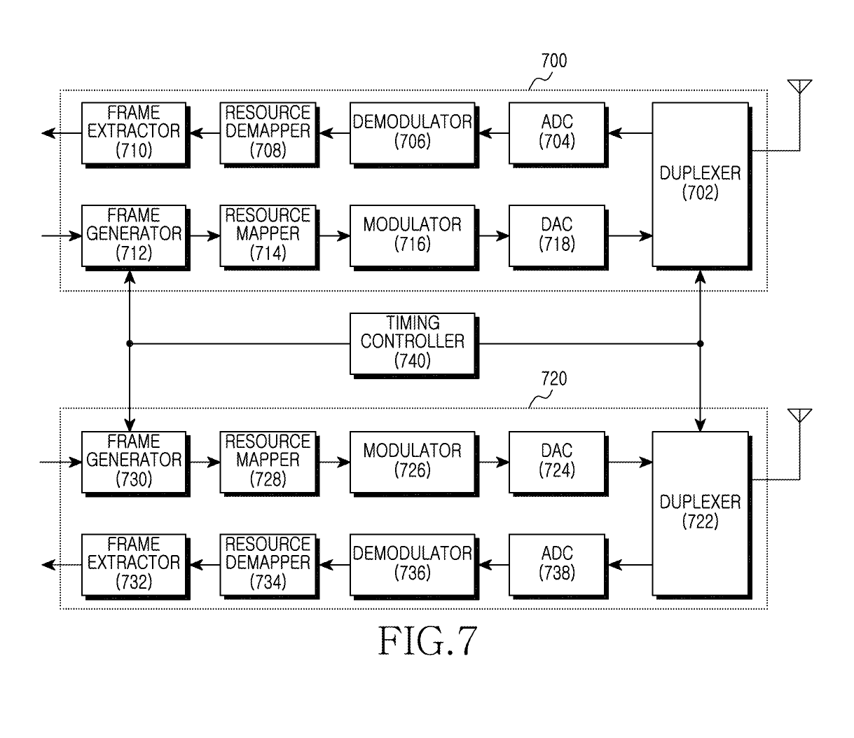

FIG. 7 illustrates an RS apparatus in a multi-hop wireless communication system according to an exemplary embodiment of the present invention.

Referring to FIG. 7, the RS includes a first transmission/reception unit 700, a second transmission/reception unit 720, and a timing controller 740.

The first transmission/reception unit 700 transmits/receives a signal using a DL frequency band, and the second transmission/reception unit 720 transmits/receives a signal using a UL frequency band. Here, the first transmission/reception unit 700 and the second transmission/reception unit 720 use a different frequency band used for transmitting/receiving a signal, and have the same construction. Accordingly, the first transmission/reception unit 700 is described below as representation, and a description of the second transmission/reception unit 720 is omitted for brevity.

The first transmission/reception unit 700 includes a duplexer 702, a transmission unit, and a reception unit.

The duplexer 702 transmits a transmit signal received from the transmission unit according to a duplexing scheme through an antenna, and provides a receive signal from the antenna to the reception unit.

The reception unit includes an Analog to Digital Converter (ADC) 704, a demodulator 706, a resource demapper 708, and a frame extractor 710.

The ADC 704 converts an analog signal provided from the duplexer 702, into a digital signal. The demodulator 706 demodulates the digital signal provided from the ADC 704 according to a corresponding modulation level (i.e., a Modulation and Coding Scheme (MCS) level), and outputs the demodulated digital signal.

The resource demapper 708 extracts a frame allocated to a burst of each link provided from the demodulator 706.

The frame extractor 710 extracts a frame corresponding to the RS, from the frame provided from the resource demapper 708.

The transmission unit includes a frame generator 712, a resource mapper 714, a modulator 716, and a Digital to Analog Converter (DAC) 718.

The frame generator 712 generates a frame depending on a control signal provided from the timing controller 740. For example, the frame generator 712 configures an RS DL frame as illustrated in FIG. 3. At this time, the frame generator 712 can determine an R-TTI 340 and an R-RTI 350 using Equations 1 and 2. For another example, a frame generator 730 of the second transmission/reception unit 720 configures an RS UL frame as illustrated in FIG. 4. At this time, the frame generator 730 can determine an R-TTI 460 and an R-RTI 450 using Equation 3 or 5.

The resource mapper 714 allocates frames generated in the frame generator 712 to a burst of a corresponding link, and outputs the allocated frames.

The modulator 716 modulates the frames allocated to the burst of each link provided from the resource mapper 714, according to a corresponding modulation level.

The DAC 718 converts a digital signal provided from the modulator 716 into an analog signal, and outputs the analog signal to the duplexer 702.

The timing controller 740 generates an RS DL frame of FIG. 3, and transmits a control signal for transmitting/receiving a signal according to a structure of the RS DL frame to the first transmission/reception unit 700. Also, the timing controller 740 generates an RS UL frame of FIG. 4, and transmits a control signal for transmitting/receiving a signal according to the RS UL frame to the second transmission/reception unit 720. At this time, the timing controller 740 generates a control signal such that the first transmission/reception unit 700 and the second transmission/reception unit 720 transition between reception/transmission considering an R-TTI and an R-RTI identified through the procedure of FIG. 6.

An FDD wireless communication system differently sets a DL frequency band and a UL frequency band. For example, the wireless communication system sets each of the DL and UL frequency bands such that the DL frequency band and the UL frequency band are separated from each other. In another example, the wireless communication system may set each of the DL and UL frequency bands such that the DL frequency band and the UL frequency band are adjacent to each other. In this case, a guard band exists between the DL frequency band and the UL frequency band.

Herein, duplexer 702, ADC 704, demodulator 706, resource demapper 708, frame extractor 710, frame generator 712, resource mapper 714, modulator 716, and DAC 718 of transmission/reception unit 700, is similar to duplexer 722, ADC 724, demodulator 726, resource demapper 728, frame extractor 730, frame generator 732, resource mapper 734, modulator 736, and DAC 738 of transmission/reception unit 720, respectively.

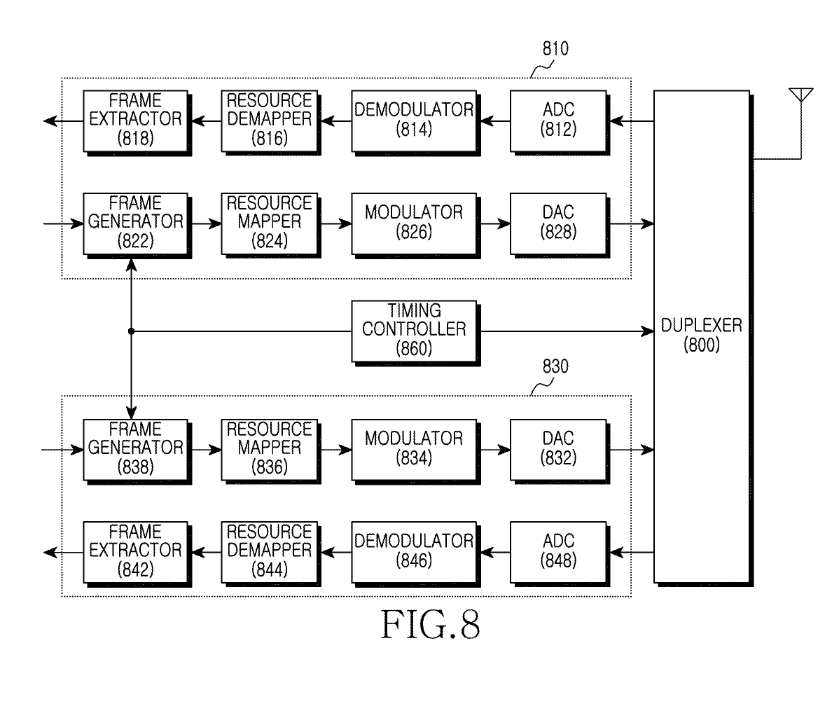

In a case where the DL frequency band and the UL frequency band are set adjacently, an RS for setting an R-TTI and an R-RTI can be constructed described below with reference to FIG. 8.

FIG. 8 illustrates an RS apparatus in a relay wireless communication system according to an exemplary embodiment of the present invention.

Referring to FIG. 8, the RS includes a duplexer 800, a first transmission/reception unit 810, a second transmission/reception unit 830, and a timing controller 860.

The duplexer 800 separates a signal of a DL frequency band from a signal of a UL frequency band according to a duplexing scheme. That is, the duplexer 800 controls and transmits a signal provided from the first transmission/reception unit 810, through the DL frequency band, and provides a signal received through the DL frequency band to the first transmission/reception unit 810. Also, the duplexer 800 controls and transmits a signal provided from the second transmission/reception unit 830, through the UL frequency band, and provides a signal received through the UL frequency band to the second transmission/reception unit 830.

The first transmission/reception unit 810 transmits/receives a signal using a DL frequency band, and the second transmission/reception unit 830 transmits/receives a signal using a UL frequency band. Here, the first transmission/reception unit 810 and the second transmission/reception unit 830 use a different frequency band used for transmitting/receiving a signal, and have the same construction. Accordingly, the first transmission/reception unit 810 is described below as representation, and a description of the second transmission/reception unit 830 is omitted for brevity.

The first transmission/reception unit 810 includes a transmission unit and a reception unit.

The reception unit includes an ADC 812, a demodulator 814, a resource demapper 816, and a frame extractor 818.

The ADC 812 converts an analog signal provided from the duplexer 800, into a digital signal. The demodulator 814 demodulates the digital signal provided from the ADC 812 according to a corresponding modulation level (i.e., an MCS level), and outputs the demodulated digital signal.

The resource demapper 816 extracts a frame allocated to a burst of each link provided from the demodulator 814.

The frame extractor 818 extracts a frame corresponding to the RS, from the frame provided from the resource demapper 816.

The transmission unit includes a frame generator 822, a resource mapper 824, a modulator 826, and a DAC 828.

The frame generator 822 generates a frame depending on a control signal provided from the timing controller 860. For example, the frame generator 822 configures an RS DL frame as illustrated in FIG. 3. At this time, the frame generator 822 can determine an R-TTI 340 and an R-RTI 350 using Equations 1 and 2. For another example, a frame generator 838 of the second transmission/reception unit 830 configures an RS UL frame as illustrated in FIG. 4. At this time, the frame generator 838 can determine an R-TTI 460 and an R-RTI 450 using Equation 3 or 5.

The resource mapper 824 allocates frames generated in the frame generator 822 to a burst of a corresponding link, and outputs the allocated frames.

The modulator 826 modulates the frames allocated to the burst of each link provided from the resource mapper 824, according to a corresponding modulation level.

The DAC 828 converts a digital signal provided from the modulator 826 into an analog signal, and outputs the analog signal to the duplexer 800.

The timing controller 860 generates an RS DL frame of FIG. 3, and transmits a control signal for transmitting/receiving a signal according to a frame configuration scheme to the first transmission/reception unit 810. Also, the timing controller 860 generates an RS UL frame of FIG. 4, and transmits a control signal for transmitting/receiving a signal according to the frame configuration scheme to the second transmission/reception unit 830. At this time, the timing controller 860 generates a control signal such that the first transmission/reception unit 810 and the second transmission/reception unit 830 transition between reception/transmission based on considering an R-TTI and an R-RTI identified through the procedure of FIG. 6.

Herein, ADC 812, demodulator 814, resource demapper 816, and frame extractor 818, frame generator 822, resource mapper 824, modulator 826, and a DAC 828 of first transmission/reception unit 810, is similar to ADC 832, demodulator 834, resource demapper 836, and frame extractor 838, frame generator 842, resource mapper 844, modulator 846, and a DAC 848 of second transmission/reception unit 830, respectively.

The exemplary embodiments of the present invention have an advantage of being capable of enhancing the data transmission efficiency of a system by removing an unnecessary transition gap from an FDD frame of a relay wireless communication system as described above.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operation method of a Relay Station (RS) in a Frequency Division Duplex (FDD) wireless communication system, the method comprising:
determining transmission/reception transition time information through a negotiation with an upper node;
identifying a signal delay time with the upper node;
identifying a first reference time;
determining an overhead of a DownLink (DL) frame and an overhead of an UpLink (UL) frame resulting from a transmission/reception transition in consideration of at least one of the transition time information, the signal delay time, the first reference time, and a second reference time; and
performing communication considering the overhead of the DL frame and the overhead of the UL frame,
wherein a start time point of the UL frame is set to precede a start time point of a UL frame of the upper node in consideration of the first reference time,
wherein the first reference time represents a time zone positioned between a UL frame of the RS and a next UL frame, and
wherein the second reference time represents a time zone for constantly maintaining lengths of a DL frame of the upper node and a UL frame.

2. The method of claim 1, wherein the signal delay time is acquired in one of an initial access and random access process with the upper node.

3. The method of claim 1, wherein the determining of the transmission/reception transition time information comprises determining the transmission/reception transition time information through a capability negotiation with the upper node.

4. The method of claim 1, wherein the transmission/reception transition time information comprises a Relay Station Transmit/receive Transition Gap (RSTTG) and a Relay Station Receive/transmit Transition Gap (RSRTG).

5. The method of claim 1, wherein the identifying of the first reference time comprises identifying the first reference time provided from the upper node.

6. The method of claim 1, wherein the identifying of the first reference time comprises determining the first reference time using time information provided from the upper node, and
wherein the time information is time information for setting the start time point of the UL frame of the RS to precede the start point time of the UL frame of the upper node.

7. The method of claim 1, wherein the determining of the overhead comprises:
if a Relay Station Transmit/receive Transition Gap (RSTTG) of the RS is less than or equal to the signal delay time, determining that the overhead of the DL frame resulting from the RSTTG does not exist; and
if the RSTTG of the RS is greater than the signal delay time, determining a Relay-Transmit/receive Transition Interval (R-TTI), which is the overhead of the DL frame resulting from the RSTTG, in consideration of the RSTTG of the RS and the signal delay time, and
wherein the R-TTI is determined in the unit of an Orthogonal Frequency Division Multiplexing (OFDM) symbol.

8. The method of claim 1, wherein the determining of the overhead comprises:
if a Relay Station Receive/transmit Transition Gap (RSRTG) of the RS is less than or equal to a difference between the second reference time and the signal delay time, determining that the overhead of the DL frame resulting from the RSRTG does exist; and
if the RSRTG of the RS is greater than the difference between the second reference time and the signal delay time, determining a Relay-Receive/transmit Transition Interval (R-RTI), which is the overhead of the DL frame resulting from the RSRTG, in consideration of the RSRTG of the RS and the signal delay time, and
wherein the R-RTI is determined in the unit of an Orthogonal Frequency Division Multiplexing (OFDM) symbol.

9. The method of claim 1, wherein determining the overhead comprises, if a sum of a Relay Station Transmit/receive Transition Gap (RSTTG) and Relay Station Receive/transmit Transition Gap (RSRTG) of the RS is less than or equal to the second reference time, determining that the overhead of the UL frame resulting from the RSTTG and RSRTG does not exist.

10. The method of claim 1, wherein determining the overhead comprises, if a sum of a Relay Station Transmit/receive Transition Gap (RSTTG) and Relay Station Receive/transmit Transition Gap (RSRTG) of the RS is greater than the second reference time, determining any one of a Relay-Transmit/receive Transition Interval (R-TTI) and a Relay-Receive/transmit Transition Interval (R-RTI), which are overheads of the UL frame resulting from the RSTTG and RSRTG, as a size of at least one Orthogonal Frequency Division Multiplexing (OFDM) symbol.

11. The method of claim 1, wherein the upper node is a BS or an upper RS.

12. A Relay Station (RS) apparatus in a Frequency Division Duplex (FDD) wireless communication system, the apparatus comprising:
a timing controller for determining overheads of a DownLink (DL) frame and UpLink (UL) frame resulting from transmission/reception transition in consideration of at least one of a transmission/reception transition time determined through a negotiation with an upper node, a signal delay time with the upper node, a first reference time, and a second reference time, and for providing a timing signal for transmission/reception transition of the RS in consideration of the overheads of the DL frame and UL frame;
a first transmission/reception unit for transmitting/receiving a signal through a DL frequency band, and for transitioning between transmission/reception based on the timing signal provided from the timing controller; and
a second transmission/reception unit for transmitting/receiving a signal through a UL frequency band, and for transitioning between transmission/reception based on the timing signal provided from the timing controller,
wherein the timing controller provides a timing signal for a start time point of the UL frame of the RS set to precede a start time point of a UL frame of the upper node in consideration of the first reference time,
wherein the first reference time represents a time zone positioned between a UL frame of the RS and a next UL frame, and
wherein the second reference time represents a time zone for constantly maintaining lengths of a DL frame of the upper node and a UL frame.

13. The apparatus of claim 12, wherein the timing controller acquires the signal delay time with the upper node in one of an initial access and random access process with the upper node.

14. The apparatus of claim 12, wherein the timing controller determines transmission/reception transition time information through a capability negotiation with the upper node.

15. The apparatus of claim 12, wherein the transmission/reception transition time information comprises a Relay Station Transmit/receive Transition Gap (RSTTG) and a Relay Station Receive/transmit Transition Gap (RSRTG).

16. The apparatus of claim 12, wherein the timing controller identifies the first reference time provided from the upper node.

17. The apparatus of claim 12, wherein the timing controller determines the first reference time using time information provided from the upper node, and
wherein the time information is time information for setting the start time point of the UL frame of the RS to precede the start point time of the UL frame of the upper node.

18. The apparatus of claim 12, wherein, if a Relay Station Transmit/receive Transition Gap (RSTTG) of the RS is less than or equal to the signal delay time, the timing controller determines that the overhead of the DL frame resulting from the RSTTG does not exist and, if the RSTTG of the RS is greater than the signal delay time, the timing controller determines a Relay-Transmit/receive Transition Interval (R-TTI), which is the overhead of the DL frame resulting from the RSTTG, in consideration of the RSTTG of the RS and the signal delay time, and
wherein the R-TTI is determined in the unit of an Orthogonal Frequency Division Multiplexing (OFDM) symbol.

19. The apparatus of claim 12, wherein, if a Relay Station Receive/transmit Transition Gap (RSRTG) of the RS is less than or equal to a difference between the second reference time and the signal delay time, the timing controller determines that the overhead of the DL frame resulting from the RSRTG does exist and, if the RSRTG of the RS is greater than the difference between the second reference time and the signal delay time, the timing controller determines a Relay-Receive/transmit Transition Interval (R-RTI), which is the overhead of the DL frame resulting from the RSRTG, in consideration of the RSRTG of the RS and the signal delay time, and
wherein the R-RTI is determined in the unit of an Orthogonal Frequency Division Multiplexing (OFDM) symbol.

20. The apparatus of claim 12, wherein, if a sum of a Relay Station Transmit/receive Transition Gap (RSTTG) and Relay Station Receive/transmit Transition Gap (RSRTG) of the RS is less than or equal to the second reference time, the timing controller determines that the overhead of the UL frame resulting from the RSTTG and RSRTG does not exist.

21. The apparatus of claim 12, wherein, if a sum of a Relay Station Transmit/receive Transition Gap (RSTTG) and Relay Station Receive/transmit Transition Gap (RSRTG) of the RS is greater than the second reference time, the timing controller determines any one of a Relay-Transmit/receive Transition Interval (R-TTI) and a Relay-Receive/transmit Transition Interval (R-RTI), which are overheads of the UL frame resulting from the RSTTG and RSRTG, as a size of at least one OFDM symbol.

22. The apparatus of claim 12, wherein the upper node is a BS or an upper RS.
